(19) United States
(12) Patent Application Publication
(10) Pub. No.: US 2008/0315163 A1
(43) Pub. Date: Dec. 25, 2008

(54) Building Material

(75) Inventors: Jorn Schroer, Herdecke (DE); Dieter Jablonka, Herdecke (DE); Heinz Raidt, Dortmund (DE); Rudiger Laur, Dortmund (DE)

Correspondence Address: SHERIDAN ROSS PC, 1560 BROADWAY, SUITE 1200, DENVER, CO, 80202, US

(73) Assignee: EWALD DÖRKEN AG, Herdecke (DE)

(21) Appl. No.: 12/090,073

(22) PCT Filed: Sep. 20, 2006
(86) PCT No.: PCT/EP2006/009107

§ 371 Date: Aug. 4, 2008

(30) Foreign Application Priority Data
Oct. 14, 2005 (DE) 10 2005 049 733.0
Nov. 3, 2005 (DE) 10 2005 052 925.9

(51) Int. Cl. C09D 5/26

(52) U.S. Cl. 252/586

(57) ABSTRACT

Building material for use in the building industry. According to the invention, the building material comprises at least one thermochromic material which changes colour and/or transparency depending on a switching temperature, the colour and/or transparency changing occurring in the temperature range of the lower and/or upper processing temperature of the building material and/or the processing temperature of another building material to be processed with the claimed building material.

The invention relates to a building material for use in construction. The present invention further relates to a packaging material for the packaging of building materials as well as a label for the labeling of building material.

The building materials used in the construction field, particular in the area of building construction, can generally only be processed in certain temperature ranges. If the ambient temperature and hence the temperature of the building material or of a subsurface onto which the building material is to be applied is too low or too high, proper processing is sometimes not possible. If the processing instructions are not followed with sufficient care, then the building materials may be damaged or destroyed or damage may occur at the construction site after processing of the building materials, which can be attributed to improper processing at excessively low or excessively high temperatures. For instance, the adhesiveness of adhesive materials, particularly of adhesive tapes, adhesive films, carpet adhesive, tile adhesive or the like is severely limited at excessively low processing temperatures, which may make adhesion impossible. Coatings such as paints or primers, for example, likewise do not adhere at excessively low temperatures or excessively high temperatures.

It is therefore the object of the invention to make available a novel building material for use in the building industry which can be processed in a simple manner.

In order to achieve the foregoing object, the building material according to the invention has at least one thermochromic material, with the thermochromic material changing in color and/or transparency depending on a switching temperature and with a change in color and/or transparency occurring in the temperature range of the lower and/or upper processing temperature of the building material and/or of another building material to be processed with the building material.

Thermochromy includes the characteristic of a material to reversibly or irreversibly change its color and/or transparency depending on the temperature. The invention is based on the fundamental idea of making the undershoot of the lower processing temperature and/or the overshoot of the upper processing temperature of the building material and/or of another building material to be processed with the building material recognizable through a change in color or transparency of the thermochromic material. In this way, damage occurring during the processing of the building material according to the invention at excessively low or excessively high material temperatures and/or ambient temperatures can be prevented in a simple manner. Moreover, it can be judged in a simple manner whether it is even possible to process the building material in question at the prevalent ambient temperatures, with a change in the color and/or transparency of the building material showing that a reliable processing temperature of the building material has been under- or overshot.

The selection of a thermochromic material is done depending on the reliable or preferred processing temperature of the building material, with the switching temperature of the thermochromic material determining, among other things, its suitability for use as an indicator for the processability of the building material in question. In this context, the processability of a building material can be determined, for example, by the adhesiveness of an adhesive provided depending on the relative humidity at the construction site. As the air temperature drops, the relative humidity increases. Here, a thermochromic material can be selected whose switching temperature corresponds to the dew point temperature of the moist air at a certain water vapor content, so that an undershoot of the dew point and hence the limit temperature for the processing of the adhesive can be indicated.

In terms of the invention, the switching temperature can particularly be the upper switching temperature or changing temperature of the thermochromic material. Upon reaching the upper switching temperature, the thermochromic material is essentially colorless. As the temperature drops, the color intensity of the thermochromic material increases, until the color intensity has attained a maximum upon reaching the lower switching temperature. The temperature range between the upper and the lower switching temperature is referred to in the following as “switching temperature range.” Moreover, thermochromic materials are known whose color intensity increases as the temperature increases, so that the thermochromic material has a maximum color intensity upon reaching the upper switching temperature. In addition, thermochromic materials are known which are one color at temperatures below the lower switching temperature and are another color at temperatures above the upper switching temperature.

A wide variety of color switching arrangements can be made in previously determined switching temperature ranges. The color switching arrangements can be implemented over a broad switching temperature range of ΔT between 0.1° C. to 25° C. or, preferably, over a narrow temperature range of ΔT between 0.1° C. to 5° C. The narrower the switching temperature range, the easier it is to recognize an overshoot or an undershoot of a required or permissible processing temperature of the building material.

The building material according to the invention can be used particularly in the area of building construction. Preferably, the building material according to the invention can be sheet-, strip- or plate-shaped building materials such as, for example, adhesive strips, (self-adhesive) films, sealing sheets, support materials such as decoupling sheets and dimpled sheets, vapor barriers or retarders, sarking membranes, construction fabric or interlaid scrim made of fibers and/or filaments, gypsum plasterboards, particle boards, (facade) plates, papers, cardboards, wallpapers or the like. Included among the plate-shaped building materials are, among other things, stones and tiles. Flowable and spreadable as well as adherable, fillable and applicable masses also fall under the term “building material,” for example primers, adhesives, plasters, cements, screed flooring, loams, (printing) inks, glazes, coatings, finishes or the like. Finally, injection-molded parts used in the building industry may have at least one thermochromic material in order to detect the processing temperature of the injection-molded part and/or of another building material to be processed with the building material. The aforementioned building materials have been selected for the sake of example, and other inherently known building materials can be functionalized correspondingly through the use of a thermochromic material.

As already mentioned, the aforementioned building materials can be used primarily in the area of building construction. In principle, however, any building materials from other areas of construction, for example from automobile manufacturing, can also have at least one thermochromic material which indicates an undershoot or overshoot of the processing temperature.

In terms of the invention, the processing temperature is the permissible and/or manufacturer-specified minimum or maximum material temperature or a permissible ambient temperature which makes it possible to properly process the building material as such, for example an adhesive, a paint or a primer, or another building material to be processed with the building material. In relation to the invention, the term “processing temperature” is also to be understood as a functional temperature, where the functional temperature can be the temperature or the temperature range at which or in which the functionality of the building material is ensured. The building material can be, for example, a commercially available tile adhesive which is to be applied to a decoupling mat inserted between a subsurface and a ceramic covering. The decoupling mat can contain the thermochromic material whose switching temperature is adapted to the required or permissible processing temperature of the tile adhesive. The decoupling mat indicates through color change the processing limit for the tile adhesive as a function of the material temperature of the decoupling mat. As a result, the processing temperature is the temperature which permits the proper laying, adhering, application, filling, etc. of the building material, and the functional temperature is the temperature at which the required function of the building material is ensured. The processing temperature or the functional temperature of the building material is determined by the ambient temperature at the construction site or the temperature of a subsurface of the construction site to which the building material is joined. The switching temperature of the thermochromic material can correspond substantially to the processing temperature of the building material. In principle, it is of course also possible that the switching temperature deviate from the permissible or required processing temperature, preferably by a maximum of +/−10° C., particularly by +/−5° C. In this manner, it can be ensured that a visible or user-recognizable change in the color and/or transparency of the thermochromic material occurs to a considerable extent only upon a “palpable” undershoot of the lower processing temperature and/or upon an overshoot of the upper processing temperature.

The thermochromic material can be selected as a function of the respective processing temperature of the building material and/or of the other building material, with the processing temperature depending, among other things, on the type and structure of the building material and the area of application or function. In this regard, the thermochromic material can have a switching temperature of ca. 0° C. to 15° C., preferably ca. 5° C. to 10° C., and particularly a switching temperature of ca. 5° C. A switching temperature in the range of the freezing temperature of water can be provided particularly for water-based building materials in order to detect the freezing point. The upper processing temperature can lie in the range between 30° C. and 70° C., preferably in the range between 40° C. and 60° C., so that the thermochromic material can have a switching temperature from the aforementioned temperature ranges to indicate the upper processing temperature.

Preferably, a provision is further made that, upon reaching the switching temperature, a reversible change in the color and/or transparency of the thermochromic material occurs. Through reversible color switching, the proper processing of the building material is simplified. For example, it is possible at excessively low ambient temperatures to stop the processing of the building material and to continue with processing as soon as the ambient temperature has risen sufficiently, which is indicated by a change in the color and/or transparency of the thermochromic material.

A large part of the aforementioned building materials such as, for example, films, coatings, sealing masses and, particularly, water-based building materials, can only be stored or only fulfill their function on a sustained basis within a certain temperature window. The indication of improper storage or usage or application temperatures is hardly possible for suppliers and manufacturers, or only so at great expense. If the building materials are stored or used over a certain time period at temperatures below or above the permissible storage or usage temperatures, damage or destruction of the building material may occur. Proper processing is then no longer possible.

It is therefore also the object of the invention to make available a building material for use in the building industry which can be processed properly in a simple manner.

The aforementioned object is achieved in a building material according to the invention for use in the building industry in that at least one thermochromic material is provided, with the thermochromic material changing the color and the transparency depending on a switching temperature, and with a change in color and/or transparency occurring in the temperature range of the lower and/or upper storage or usage temperature of the building material.

Here, the invention is further based on the fundamental idea of providing at least one thermochromic material which changes its color and/or transparency depending on the storage and/or (long-term) usage temperature of the building material and thus indicates an undershoot or overshoot of permissible storage and/or usage temperatures in a simple manner. Here too, the building material can be the materials named at the outset. The usage temperature is defined in terms of the invention as the permissible or required temperature at which the storability or usability of the building material is ensured over a predetermined time period.

The switching temperature may correspond substantially to the storage and/or usage temperature of the building material or deviate from the storage and/or usage temperature preferably by a maximum of +/−20° C., particularly by +/−10° C. In relation to the detection of the storage and/or usage temperature, it is generally sufficient to indicate a significant undershoot or overshoot of the permissible or required temperatures, since the building materials in question generally permit a slight undershoot or overshoot of the storage and/or usage temperature without suffering damage.

Preferably, a further provision is made in this context that an irreversible change in the color and/or transparency occurs as soon as the material temperature of the building material has reached the switching temperature of the thermochromic material. In this manner, it can be ensured that damage that can be attributed to a significant overshoot or undershoot of the storage and/or usage temperature of the building material is indicated in all cases, even if the temperature once again lies in the permissible or required temperature range at a later time.

In this context, the thermochromic material can have a switching temperature of ca. 80° C. to 100° C., preferably ca. 90° C., to detect overheating. Through appropriate thermochromic materials, an undercooling of the building material can also be detected. This is particularly significant in water-conducting systems.

At the construction site, temperature inhomogeneities contribute to energy losses and lead to a greater heating requirement and thus to higher heating costs. Another possible consequence of temperature inhomogeneities at the construction site is that the building materials to be processed there cannot be processed properly, at least in areas, or the functionality of the building material in the area in which temperature inhomogeneities occur is not ensured. In terms of the invention, the term “temperature inhomogeneity” is to be understood as a temperature gradient which can occur between at least two adjacent surfaces or sections at the construction site. If a temperature inhomogeneity occurs in the ground, for example, then the temperatures of the sections of ground in the area of the temperature inhomogeneity differ from each other so much that the proper processing or the functionality of the building material is not ensured in the area of the section of ground with the higher or lower temperature.

Temperature inhomogeneities are caused, for example, by thermal bridges. A thermal bridge is an area in components of a building through which the heat is transported to the outside more quickly than through the other components. Thermal bridges can be caused, for one, by materials having different thermal conductivities or by convection currents. Constructive thermal bridges occur, for example, as a result of internal parts or building materials having a greater thermal conductivity or a lack of thermal attenuation, e.g. reinforced concrete parts or lines which penetrate through an attenuated external wall. Geometric thermal bridges result, for example, from protrusions/corners in an otherwise homogeneous component if the inner surface opposes a larger outer surface through which the heat escapes. In the area of thermal bridges, the interior surface temperature of components drops in winter. When the temperature drops below the dew point, condensation forms. There is therefore the danger of mold formation at thermal bridges.

If convection currents, for example due to air leaks in the external building shell, are the cause of temperature inhomogeneities, they can be discovered by means of a so-called blower door test. But this is tedious in execution and associated with high costs. Heating coils, particularly of water or electric floor heating systems, can also lead to the formation of temperature inhomogeneities and can be detected or located in a building only at considerable expense. The same applies to live cables. Live cables can be detected via electromagnetic fields, but only if the cables are not shielded. Plastic tubes, by contrast, cannot be found via electromagnetic fields.

In order to prevent temperature inhomogeneities, the building materials in question must be processed with the utmost care, which takes a lot of time and requires a high level of technical knowledge.

It is therefore also the object of the invention to make available a building material for use in the building industry which can be processed properly in a simple manner.

The aforementioned object is achieved in a building material according to the invention in that at least one thermochromic material is provided, with the thermochromic material changing in color and/or transparency depending on a switching temperature, and with a change in color and/or transparency occurring in the temperature range of the temperature gradient occurring in a temperature inhomogeneity in order to detect temperature inhomogeneities of a subsurface of the building material and/or in the surroundings of the building material. Here, the invention is based on the fundamental idea of providing a thermochromic material which enables the detection or location, as early as possible during the processing of the building material, of temperature inhomogeneities at the construction site through a change in the color and/or transparency of the building material which is to be installed in the area of the temperature inhomogeneities. A temperature inhomogeneity of the subsurface or of the surroundings results in two areas of the building material having a different temperature. If the thermochromic material is provided in the area of the building material in which the temperature gradient occurs, the temperature inhomogeneity is indicated through a change in the color and/or transparency of the thermochromic material. In this context, a provision is preferably made that the building material contains the thermochromic material in bulk or that the building material is coated over its entire visible side with the thermochromic material. In principle, it is of course also possible that the thermochromic material be provided in the form of strips or in sections on the visible side of the building material in order to indicate temperature inhomogeneities in the surroundings or of the subsurface.

The building materials according to the invention are preferably wind/vapor barriers, vapor retarders, sarking membranes, gypsum plasterboards, particle boards, plasters, (wall) paints, adhesive tapes or attenuating materials as well as papers, cardboards, wallpapers. Moreover, other building materials described at the outset which have a thermochromic material with a switching temperature in the temperature range of a thermal bridge such as, for example, stones, (facade) plates or tiles, can be provided to detect temperature inhomogeneities and/or to detect utility lines such as heating coils and power cables.

The thermochromic material can have a switching temperature of ca. 10° C. to 20° C., preferably ca. 13° C. to 15° C. If the building material is a vapor retarder/vapor barrier as an interior air seal layer, temperature inhomogeneities can be detected which can be attributed to intermediate spaces in rafters or bays that are filled incompletely with thermal insulation on the one hand, or on the other hand to a lack of air-tightness. If the temperature gradients are sufficient, i.e. preferably greater than ca. 16° C. interior space temperature and less than 10° C. exterior temperature, the faulty areas or the thermal bridges can be localized quickly and easily by means of the discolorations occurring preferably below 13° C. The application in the interior air seal layer is particularly advantageous, since the elimination of the faults is simple and associated with little cost even after the processing of the building material.

Moreover, the thermochromic material can have a switching temperature of ca. 20° C. to 30° C., preferably of ca. 26° C. to 28° C. In residential buildings, the aforementioned switching temperatures can be provided in order to locate pipes with relatively low temperatures. Examples of building materials that can be used here are plasters, screeds, paints, wallpaper bases, films and decoupling mats, where the thermochromic material is to be selected in accordance with the required switching temperature. Preferably, when the switching temperature is reached, a reversible change in color and/or transparency occurs.

In order to enable an undershoot or overshoot of a plurality of different processing, storage or usage temperatures [sic] as well as the detection of thermal bridges that can occur at different temperatures, at least one other thermochromic material with another switching temperature can be provided. For example, a first thermochromic material can be provided to detect an overshoot or undershoot of the processing temperature of the building material, for example the processing temperature of a film sheet. By contrast, a second thermochromic material of the building material can be provided in order to indicate an undershoot or overshoot of the processing temperature of another building material—an adhesive, for instance—to be processed with the film sheet.

The thermochromic material is preferably provided at least on the front side of the building material. The front side is in reference to the processing, storage, or usage state of the building material.

The building material must be obtainable from at least one flowable or spreadable or powdery starting material through the addition of the thermochromic material to the starting material, where the thermochromic material can be added subsequently to the building material as such or already added to the starting materials during the manufacture of the building material. The thermochromic material can be added directly to the building material or to its starting components especially in brushable or flowable or liquid building materials or in building materials which are manufactured just before processing such as, for example, plaster, loam or cement. By contrast, if the building material is in the form of a sheet, tape or plate, a support layer coated or imprinted at least in areas with the thermochromic material or a support body coated or imprinted at least in areas with the thermochromic material can be provided. If the building material is coated or imprinted in part with the thermochromic material, this contributes to the low manufacturing costs of the building material according to the invention. In principle, it is of course also possible that, in sheet-, tape- or plate-shaped building materials, a support layer containing the thermochromic material or a support body containing the thermochromic material be provided or that the building material as such, which is to say in bulk, contains the thermochromic material or is colored in bulk.

The building material can have a multilayer construction with a plurality of different layers, where a thermochromic material can be provided in at least one layer. A support layer of the building material can be obtained, for example, through extrusion of at least one polymer material under admixture of the thermochromic material and, optionally, of a UV absorber substance or UV absorption material. The UV absorber substance is provided as protection against damaging of the thermochromic material by UV radiation. In another preferred embodiment, the support layer can be obtained through coextrusion of at least two polymer materials, with, preferably, only one polymer material containing the thermochromic material. The aforementioned methods for the manufacture of a support layer with thermochromic characteristics are simple and economical to execute.

Preferably, the building material contains the thermochromic material in uniform distribution. However, it is also possible in principle that the thermochromic material be distributed inhomogeneously. For example, it is possible to extrude at least two polymer materials with different viscosities under admixture of the thermochromic material, which leads to an inhomogeneous distribution of the thermochromic material in the thus-obtained polymer film. An inhomogeneous distribution can also be achieved by adding the thermochromic material, optionally with a supporting substance, only at the end of an extrusion process, so that a homogeneous mixing with a polymer melt is no longer possible. The inhomogeneous distribution of the thermochromic material may result in a more pronounced change in color and/or transparency upon reaching the switching temperature in partial areas of the building material, which facilitates the recognition of a temperature under- or overshoot.

The building material according to the invention can have at least one thermochromic adhesive layer, where the adhesive layer can preferably be joined to a raw material of the building material according to the invention, particularly of a support layer. In this context, the thermochromic material is preferably added to the adhesive in a flowable state, which leads to a homogeneous distribution of the thermochromic material in the adhesive layer.

Moreover, a thermochromic fleece layer can be provided which can preferably be obtained through admixture of the thermochromic material and, optionally, a UV absorber material to a polymer melt used for the manufacture of the fleece. The fleece layer can be used as a sheet or as a part of a composite of several layers and be joined to a polymeric base film.

For protection, an external transparent protective can be further provided, which preferably has a UV absorber material.

In order to achieve the objects named in the foregoing, the packaging material according to the invention for packaging building materials or the label according to the invention for labeling building materials can have at least one thermochromic material, with the thermochromic material changing in color and/or transparency depending in a switching temperature and with a change in the color and/or transparency occurring in the temperature range of the lower and/or of the upper processing and/or storage and/or usage temperature of the building material. Through the use of thermochromic materials in packaging materials and labels, it is possible to indicate an undershoot and/or an overshoot of processing and/or storage and/or usage temperatures of the thus-packaged or -labeled building materials in a simple and cost-effective manner. Consequently, the advantages achieved in relation to the building materials according to the invention can also be achieved in relation to the packaging material according to the invention and the label according to the invention. For example, thermochromic labels can be applied onto a subsurface prior to the processing of the building material in order to indicate that the temperature of the subsurface and/or the ambient temperature permit proper processing of the building material.

There are a great number of possibilities for embodying and modifying the building material according to the invention, the packaging material according to the invention, and the label according to the invention, for which purpose reference is made to the dependent claims on the one hand and to the following detailed description of preferred sample embodiments of the invention on the other hand.

### EXAMPLE 1

Example 1 relates to the manufacture of adhesive tapes. In a first embodiment of an adhesive tape, a provision is made to mix ca. 5 wt. % of a ca. 50% thermochromic dispersion, ca. 5 wt. % of a ca. 50% thermochromic dispersion with the name ChromaZone® Dispersion from Thermographic Measurements Co. Ltd. with a switching temperature of 5° C. into an acrylate dispersion, e.g. one sold under the commercial name Acronal® A 220 from BASF AG. The aforementioned thermochromic material is an aqueous dispersion containing thermochromic pigments. To manufacture the adhesive tape, an LDPE film which is silicone-treated on one side and is to a great extent UV-impermeable is coated with the acrylate dispersion described above and dried at ca. 80° C., with the dry adhesive layer having a surface weight of ca. 100 g/m². Below the switching temperature, the adhesive layer has a red coloration, which indicates that a proper processing of the adhesive tape is not possible or the adhesiveness of the adhesive is not present. At temperatures above the switching temperature range, the pigments contained in the thermochromic material are colorless, with the adhesive layer also having a light color or being likewise colorless.

In another embodiment, the LPDE film can first be imprinted at a coating weight per unit area of ca. 10 g/m² in a lattice pattern with a thermochromic paint with a switching temperature of 5° C. available under the commercial name THERMO STAR® Flexo Ink 1010 from Thermographic Measurements Co. Ltd. Subsequently, a standard acrylate dispersion is applied which is for the most part transparent. The thus-obtained layered composite is then dried. At temperatures below the upper switching temperature, the thermochromic pigments of the printing ink have a red coloration and thus indicate that proper processing of the adhesive tape is not possible.

In an alternative embodiment, during the extrusion process for the manufacture of the LDPE foil, ca. 4 wt. % of a thermochromic material with the name THERMOBATCH® from Thermographic Measurements Co. Ltd. with a switching temperature of 5° C. and 3 wt. % of a UV absorber material made of LDPE and 20 wt. % of an absorption agent containing transparent ultrafine titanium dioxide with the name Hombitec® RM 230 L from Sachtleben Chemie GmbH can be added at a coating weight of 100 g/m² as described above. At temperatures below the switching temperature, the thus-obtained LPDE film has a red coloration, which indicates that proper processing of the adhesive tape is not possible. The thermochromic material used in this embodiment has microencapsulated thermochromic pigments as well as other non-thermochromic pigments, plastic resin and paraffins.

In another embodiment, an admixture of thermochromic pigments can be provided during the silicone treatment or the external imprinting of the adhesive tape. In the former case, the silicone layer as such contains the thermochromic material.

In the place of an acrylate dispersion, a hot melt adhesive based on synthetic rubber which emerges from a nozzle in the melted state with the name TECHNOMELT® Q 8753 from Henkel Teroson GmbH can be used for the manufacture of the adhesive layer. Here, 2 wt. % of a thermochromic powdery material with the name ChromaZone® Free Flowing Powder from Thermographic Measurements Co. Ltd. with a switching temperature of 5° C. is mixed into the melted hot melt adhesive.

Alternatively to the aforementioned embodiment, a polyester film can be used which has been coated on both sides with a silicone layer. A silicone layer on the visible side contains the thermochromic material. The adhesive layer joined to the polyester film can be used as a transfer adhesive layer. The thus-obtained adhesive tape is applied at the plant to a sarking membrane. The color change at temperatures below 5° C. indicates that reliable processing of the self-seaming sarking membrane cannot be counted upon.

### EXAMPLE 2

The following sample embodiments relate to a bituminous sealing sheet and a base. The bituminous sealing sheet has an adhesive layer. The adhesive layer can have a surface weight of 150 g/m². The adhesive can be the adhesive available under the name Macromelt® from Henkel KGaA. Moreover, the adhesive layer has a thermochromic powdery material with the name ChromaZone® Free Flowing Powder from Thermographic Measurements Co. Ltd. in a proportion of 1.5 wt. %. In addition, the adhesive layer is colored white. Below the switching temperature, the adhesive layer has a red coloration, which indicates that proper processing is not possible.

A solvent-based bitumen emulsion, for example a special base such as that sold by Süddeutsche Teerindustrie GmbH & Co. KG can be provided as a base for the aforedescribed bituminous sealing sheet. Mixed into the bitumen emulsion are 2 wt. % of a red thermochromic powdery material with the name ChromaZone® Free Flowing Powder from Thermographic Measurements Co. Ltd. with a switching temperature of 5° C.

In addition to the red thermochromic material of the aforementioned type, a black thermochromic powdery material with the name ChromaZone® Free Flowing Powder from Thermographic Measurements Co. Ltd. with a switching temperature of −5° C. can be mixed in a proportion of 2 wt. % into a solvent-based bitumen emulsion with the name BAUSION-ELASTIC from Süddeutsche Teerindustrie GmbH & Co. KG. Below the switching temperature of the black thermochromic material, the emulsion has a black coloration and thus indicates that a secure adhesion to the subsurface is not possible. In the temperature range from −5° C. to +5° C., the emulsion has a red coloration, which indicates that the adhesion to the subsurface is ensured and the base can be applied to the subsurface, but the adhesion of the sealing sheet to the base is not yet possible.

### EXAMPLE 3

The following sample embodiment relates to a plaster or cement according to the invention. 5 wt. % of a ca. 50% thermochromic dispersion with the name ChromaZone® Dispersion from Thermographic Measurements Co. Ltd. with a switching temperature of 5° C. is mixed into a mixture of 50 wt. % commercial cement plaster, for example a cement plaster with the name maxit® SLK from Maxit Deutschland GmbH, and 45 wt. % water. The thermochromic material contains blue thermochromic pigments. At temperatures below 5° C., the stirred plaster has a blue coloration, which indicates that proper processing is not possible. The dried and hardened plaster also has a blue coloration at temperatures below 5° C., which indicates that a reliable application of water-based coatings is not possible. Cements or other plasters can be manufactured in the same manner, optionally using other raw materials such as plastic resin, chalk or gypsum, for example.

### EXAMPLE 4

The following sample embodiments relate to a tile adhesive and a wallpaper adhesive. 5 wt. % of a ca. 50% thermochromic dispersion with the name ChromaZone® Dispersion from Thermographic Measurements Co. Ltd. with a switching temperature of 5° C. is mixed into a mixture of 50 wt. % commercial tile adhesive, for example by the name Ardex® X7G Plus from Ardex GmbH, and 45 wt. % water. The thermochromic dispersion contains blue thermochromic pigments. At temperatures below 5° C., the stirred tile adhesive has a blue coloration, which indicates that proper processing is not possible.

To prepare a wallpaper adhesive according to the invention, a powdery thermochromic material with the name ChromaZone® Free Flowing Powder from Thermographic Measurements Co. Ltd. with a switching temperature of 10° C. is mixed in a proportion of 2 wt. % into a commercial wallpaper adhesive, for example a wallpaper adhesive with the name Ardex® T 2210 from Ardex GmbH. The thermochromic material contains blue thermochromic pigments.

### EXAMPLE 5

Example 5 relates to sheet materials with undercut dimples and a laminated-on PP fleece, for example a fleece by the name DITRA® from Schlüter-Systems GmbH, as a decoupling mat between a subsurface and ceramic coverings. During the production of the fleece, 5 wt. % of a thermochromic material with the name THERMOBATCH® from Thermographic Measurements Co. Ltd. with a switching temperature of 5° C. and 3 wt. % of a UV absorber material, for example a mixture of PP with a proportion of 20 wt. % of an absorption agent by the name Hombitec® RM 230 L from Sachtleben Chemie GmbG, are added to the polymer melt in addition to inherently known additives. At temperatures below the switching temperature, the fleece shows the processing limit for commercial tile adhesives through a color change. Alternatively, the dimpled sheet as such can be colored in bulk during manufacture with the aforementioned thermochromic material, with preferably only one of several coextruded layers being colored.

### EXAMPLE 6

The following sample embodiment relates to vapor barriers and sarking membranes. Here as well, fleeces or flat films according to Example 5 can be used as sheets or as part of a composite and contain a thermochromic material which indicates adhesiveness.

For example, a transparent base film made of PP homopolymer with a surface weight of 85 g/m² can be manufactured, with the base film containing 2 wt. % of a flame retardant under the name Flamestab NOR 116 from Ciba Spezialitätenchemie Lampertheim GmbH and 1.5 wt. % of a UV absorber material. The base film is imprinted at a coating weight per unit area of 10 g/m² in a diamond raster pattern with a thermochromic printing ink with the name THERMO STAR® Flexo Ink from Thermographic Measurements Co. Ltd., with the thermochromic material containing black thermochromic pigments with a switching temperature of 5° C. In a subsequent work step, the thus-imprinted base film is coated under the feeding of a 22/11 PP open twist weave having a surface weight of 35 g/m² with a white-colored PP homopolymer film having a surface weight of 85 g/m². When applied to the visible side, the base film exhibits a black diamond pattern at temperatures below the switching temperature.

To produce a vapor retarder, a thermochromic dispersion with the name ChromaZone® Dispersion from Thermographic Measurements Co. Ltd. having a switching temperature of 5° C. can be added to the base material of the paper during the manufacture of a paper. The vapor retarder has a three-layer construction, with each layer having a surface weight of 50 g/m². Provided between an outer thermochromic paper layer and another outer non-thermochromic paper layer is a PE layer. For manufacture of a thermochromic paper, a provision can be made to imprint the paper as described in one of the foregoing examples.

### EXAMPLE 7

The sample embodiment relates to the manufacture of a gypsum plasterboard, with the thermochromic material provided in Example 6 to color a paper being used in this sample embodiment to color a cardboard. It is equally possible to obtain a thermochromic cardboard by imprinting a cardboard with a thermochromic material. The gypsum plasterboard has a thermochromic cardboard of the aforedescribed type on at least one side.

### EXAMPLE 8

The following sample embodiment relates to a sarking membrane and labels. A thermally pre-solidified PP spunbonded fabric with a surface weight of 17 g/m² is treated with a dye bath consisting of 94 wt. % acrylate binder with the name Acronal® S 312 D from BASF AG and 6 wt. % of a thermochromic dispersion with the name Kragen Concentrate from Thermographic Measurements Co. Ltd. with an irreversible switching temperature of 90° C. This chemically resolidified fleece is affixed with a breathable film and with another conventional PP fleece to a sarking membrane or a composite. The thermochromic material enables the easy detection of a significant overshoot of the usage temperature of 80° C.

In another embodiment, a provision can be made to affix labels which have a thermochromic material with similar characteristics in regular intervals, for example at intervals of 1 m, on the backside of the sarking membrane.

### EXAMPLE 9

The sample embodiment relates to the manufacture of vapor retarders or vapor barriers as interior air seal layers for the detection of thermal bridges in buildings. First, a transparent base film made of a PP homopolymer with a surface weight of 85 g/m² is manufactured. Besides a flame retardant in a proportion by weight of 1.2 wt. % with the name Flamestab NOR 116 from Ciba Spezialitätenchemie Lampertheim GmbH, the base film contains a UB absorber material in a proportion by weight of 1.5 wt. %. The base film is imprinted at a coating weight per unit area of 10 g/m² in a diamond raster pattern with a thermochromic printing ink with the name THERMO STAR® Flexo Ink 1010 from Thermographic Measurements Co. Ltd. The thermochromic printing ink contains red thermochromic pigments with a switching temperature of 10° C. Subsequently, the imprinted base film is coated under the feeding of a 22/11 PP open twist weave having a surface weight of 35 g/m² with a white-colored PP homopolymer film having a surface weight of 85 g/m². In the application state, the base film faces toward the front side and has red diamond patterns below the switching temperature.

In another embodiment, the small strips of which the open twist weave consists are colored in bulk during manufacture with a thermochromic material, preferably during extrusion. Reference is made here to the aforedescribed examples. A product with the name THERMOBATCH® from Thermographic Measurements Co. Ltd. can be used as the thermochromic material.

In an embodiment of a variable vapor retarder whose water vapor permeability is dependent on the ambient humidity, a provision is made that a white PP spunbonded fabric with a surface weight of 35 g/m² is extrusion-coated with a mixture of 93 wt. % sodium zinc ionomer and 4 wt. % of a powdery thermochromic material with the name THERMOBATCH® from Thermographic Measurements Co. Ltd. which has a switching temperature of 13° C. and 3 wt. % of a UV absorber material. The UV absorber material is LDPE with a proportion of 20 wt. % of a UV absorber material with the name Hombitec® RM 230 L from Sachtleben Chemit GmbH.

To manufacture another embodiment of a variable vapor retarder, a provision is made to imprint a film made of PA 6 having a surface weight of 30 g/m² with a thermochromic printing ink with the name THERMO STAR® Flexo Ink 1010 from Thermographic Measurements Co. Ltd. The thermochromic printing ink contains red pigments with a switching temperature of 13° C. The film made of PA 6 is imprinted with ca. 10 g/m². Subsequently, the thus-obtained thermochromic polyamide film is laminated with another film made of PA 6 with a surface weight of 30 g/m² using a transparent hot-melt adhesive with the name Griltex D 1229 A from the company EMS-Griltech.

Another embodiment makes a provision to manufacture a vapor retarder by coating a thermochromic PP fleece having a surface weight of 80 g/m² with a translucent EVA film having a surface weight of 80 g/m². The translucent EVA film contains 3 wt. % of a UV absorption material made of LPDE and 20 wt. % of a UV absorption agent with the name Hombitec® RM 230 L from Sachtleben Chemit GmbH. During the manufacture of the thermochromic fleece, two spin-die manifolds are used, with a thermochromic material with the name THERMO-BATCH® from Thermographic Measurements Co. Ltd. being added to the polymer melt of the front-side layer in addition to inherently known additives. The proportion by weight of the thermochromic material is 5 wt. %. The thermochromic material contains thermochromic pigments with a switching temperature of 15° C.

1. Building material for use in construction containing at least one thermochromic material, wherein the thermochromic material changes in color and/or in transparency depending on a switching temperature and wherein a change in color and/or transparency occurs in the temperature range of the upper and/or lower processing temperature of the building material and/or of the processing temperature of another building material to be processed with the building material.

2. Building material as set forth in claim 1, wherein the switching temperature corresponds to the processing temperature or that the switching temperature deviates from the processing temperature by a maximum of +/−10° C., particularly by +/−5° C.

3. Building material as set forth in claim 1, wherein the thermochromic material has a switching temperature of ca. 0° C. to 15° C., preferably of ca. 5° C. to 10° C., and particularly a switching temperature of ca. 5° C.

4. Building material as set forth in claim 1, wherein the thermochromic material has a switching temperature of ca. −10° C. to 10° C., preferably of ca. −5° C. to 5° C.

5. Building material as set forth in claim 1, wherein a reversible change in color and/or transparency occurs upon reaching the switching temperature.

6. Building material for use in the building industry containing at least one thermochromic material, wherein the thermochromic material changes in color and/or transparency depending on a switching temperature and wherein a change in color and/or transparency occurs in the temperature range of the lower and/or of the upper storage and/or usage temperature of the building material.

7. Building material as set forth in claim 6, wherein the switching temperature corresponds to the storage and/or usage temperature or that the switching temperature deviates from the storage and/or usage temperature by a maximum of +/−20° C., particularly by +/−10° C.

8. Building material as set forth in claim 6, wherein an irreversible change in color occurs upon reaching the switching temperature.

9. Building material as set forth in one of claims 6, wherein the thermochromic material has a switching temperature of ca. 80° C. to 100° C., preferably 90° C.

10. Building material for use in the building industry containing at least one thermochromic material, wherein the thermochromic material changes in color and/or transparency depending on a switching temperature and wherein a change in color and/or transparency occurs in the temperature range of the temperature gradient occurring in a temperature inhomogeneity in order to detect temperature inhomogeneities of a subsurface of the building material and/or in the surroundings of the building material.

11. Building material as set forth in claim 10, wherein the thermochromic material has a switching temperature of ca. 10° C. to 20° C., preferably of ca. 13° C. to 15° C.

12. Building material as set forth in claim 10, wherein the thermochromic material has a switching temperature of ca. 20° C. to 30° C., preferably of ca. 26° C. to 28° C.

13. Building material as set forth in one of claims 10, wherein a reversible change in color and/or transparency occurs upon reaching the switching temperature.

14. Building material as set forth in claim 10, wherein at least one other thermochromic material with another switching temperature is provided.

15. Building material as set forth in claim 10, wherein the thermochromic material is provided at least on the front side of the building material.

16. Building material as set forth in claim 10, wherein the building material can be obtained from at least one flowable or spreadable or powdery starting material through the addition of the thermochromic material to the starting material.

17. Building material as set forth in claim 10, wherein the building material is sheet-, strip- or plate-shaped and has a support layer coated or imprinted at least in areas with the thermochromic material or a support body coated or imprinted at least in areas with the thermochromic material.

18. Building material as set forth in claim 10, wherein the building material is sheet-, strip- or plate-shaped and has a support layer containing the thermochromic material, particularly a polymer film, or a support body containing the thermochromic material.

19. Building material as set forth in claim 10, wherein the building material has a multilayer construction with a plurality of different layers, wherein at least one layer contains a thermochromic material.

20. Building material as set forth in claim 10, wherein the support layer can be obtained through the extrusion of at least one polymer material under admixture of the thermochromic material and, optionally, of a UV absorber substance.

21. Building material as set forth in claim 10, wherein the support layer can be obtained through coextrusion of at least two polymer materials wherein, preferably, only one polymer material contains the thermochromic material.

22. Building material as set forth in claim 10, wherein the thermochromic material is distributed inhomogeneously in the support layer wherein, preferably, the support layer can be obtained through extrusion of at least two polymer materials with different viscosities under admixture of the thermochromic material.

23. Building material as set forth in claim 10, wherein an adhesive layer containing the thermochromic material is provided.

24. Building material as set forth in claim 10, wherein a fleece layer containing the thermochromic material is provided and that, preferably, the fleece layer can be obtained through admixture of the thermochromic material and, optionally, a UV absorber material to a polymer melt used for the manufacture of the fleece.

25. Building material as set forth in claim 10, wherein an external transparent protective layer is provided.

26. Packaging material for packaging building materials containing at least one thermochromic material, wherein the thermochromic material changes in color and/or transparency depending on a switching temperature and wherein a change in color and/or transparency occurs in the temperature range of the lower and/or upper processing and/or storage and/or usage temperature of the building material and/or the processing temperature of another building material to be processed with the building material.

27. Label for labeling building materials containing at least one thermochromic material, wherein the thermochromic material changes in color and/or transparency depending on a switching temperature and wherein a change in color and/or transparency occurs in the temperature range of the lower and/or upper processing and/or storage and/or usage temperature of the building material and/or the processing temperature of another building material to be processed with the building material.
